(19) United States
(12) Patent Application Publication
(10) Pub. No.: US 2019/0101750 A1
(43) Pub. Date: Apr. 4, 2019

(54) HEAD-UP DISPLAY FOR DISPLAYING VIRTUAL IMAGES

(71) Applicant: Chunghwa Picture Tubes, LTD., Taoyuan City (TW)

(72) Inventors: Tai-Lu Lin, Kaohsiung City (TW); Jan-Tian Lian, Keelung City (TW)

(73) Assignee: Chunghwa Picture Tubes, LTD., Taoyuan City (TW)

(21) Appl. No.: 15/811,691

(22) Filed: Nov. 14, 2017

(30) Foreign Application Priority Data
Sep. 29, 2017 (CN) 201710904203.7

(51) Int. Cl. G02B 27/01; G02B 27/14

(52) U.S. Cl. CPC G02B 27/0101; B64D 43/00; G02B 2027/0138; G02B 27/14

(57) ABSTRACT

The invention provides a head-up display, including a first image source, a first reflection device, a second image source, and a light combining device. The first image source is configured to provide a first image light. The first reflection device is located beside the first image source. The second image source is located on the first reflection device and configured to provide a second image light. The second image source is located between the light combining device and the first reflection device. The first image light is sequentially reflected by the first reflection device, passes through the second image source, and reflected by the light combining device to be transmitted to user's eyes. The second image light is reflected by the light combining device to be transmitted to the user's eyes.

### CROSS-REFERENCE TO RELATED APPLICATION

This application claims the priority benefit of China application serial no. 201710904203.7, filed on Sep. 29, 2017. The entirety of the above-mentioned patent application is hereby incorporated by reference herein and made a part of this specification.

### BACKGROUND OF THE INVENTION

### Field of the Invention

The invention relates to a head-up display.

### Description of Related Art

Now head-up display is commonly used on aircraft as flight aid equipment. “Head-up” means that the user is able to see the important information he/she needs without looking down. The head-up display was first used on military airplanes for reducing the frequency of looking down to check the meters, so as to prevent interruption of attention and loss of situation awareness. Because the head-up display is convenient and helps to improve flight safety, civil aircraft has also adopted such equipment. In recent years, car manufacturers have started putting head-up displays on cars to increase the additional value of their products. However, the conventional head-up display can only display a two-dimensional image and is quite limited in terms of application.

### SUMMARY OF THE INVENTION

The invention is directed to a head-up display that achieves favorable display effects.

According to an embodiment of the invention, the head-up display includes a first image source, a first reflection device, a second image source, and a light combining device. The first image source is configured to provide a first image light. The first reflection device is located beside the first image source. The second image source is located on the first reflection device and configured to provide a second image light. The second image source is located between the light combining device and the first reflection device. The first image light is sequentially reflected by the first reflection device, passes through the second image source, and reflected by the light combining device to be transmitted to eyes of a user. The second image light is reflected by the light combining device to be transmitted to the eyes of the user.

In the head-up display according to an embodiment of the invention, the first image source includes a light source and a first display panel. The light source is configured to emit a light. The first display panel is located between the light source and the first reflection device, and the light passes through the first display panel to form the first image light.

In the head-up display according to an embodiment of the invention, the second image source includes a second display panel. The second display panel is located between the light combining device and the first reflection device. The light passes through the second display panel to form the second image light.

In the head-up display according to an embodiment of the invention, a reflection surface of the first reflection device is inclined with respect to a display surface of the first display panel and a display surface of the second display panel.

In the head-up display according to an embodiment of the invention, the display surface of the first display panel and the display surface of the second display panel are perpendicular to each other.

In the head-up display according to an embodiment of the invention, the light combining device includes a front windshield of a vehicle.

The head-up display according to an embodiment of the invention further includes a plurality of second reflection devices. The second reflection devices are respectively located on two opposite sides of the first image source. The first image light is reflected to the first reflection device by the second reflection devices.

In the head-up display according to an embodiment of the invention, the first image source includes a light source and a first display panel. The light source is configured to emit a light. The first display panel is located between the light source and the first reflection device, and the light passes through the first display panel to form the first image light. The light is sequentially reflected by the second reflection devices, reflected by the first reflection device, and passes through the second image source to form the second image light.

In the head-up display according to an embodiment of the invention, the second reflection devices are located between the first display panel and the first reflection device and are separated from the first reflection device by a distance.

In the head-up display according to an embodiment of the invention, a plurality of reflection surfaces of the second reflection devices are opposite to each other, and a plurality of angles are respectively formed between the reflection surfaces of the second reflection devices and the display surface of the first display panel.

In the head-up display according to an embodiment of the invention, the angles are larger than or equal to 90°.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic side view of the head-up display according to an embodiment of the invention.

FIG. 2 is a schematic perspective view of the projection device of the head-up display of FIG. 1.

FIG. 3 illustrates the first image and the second image respectively formed by the first image light and the second image light captured by the camera behind the light combining device of FIG. 1.

FIG. 4 is a schematic side view of the head-up display according to another embodiment of the invention.

FIG. 5 is a schematic perspective view of the projection device of the head-up display of FIG. 4.

FIG. 6 is a schematic top view of the head-up display of FIG. 4.

FIG. 7 illustrates the first virtual image and the second virtual image displayed by the head-up display of FIG. 1, as seen at the viewing angle of 30°.

FIG. 8 illustrates the first virtual image and the second virtual image displayed by the head-up display of FIG. 4, as seen at the viewing angle of 30°.

### DESCRIPTION OF THE EMBODIMENTS

Descriptions of the invention are given with reference to the exemplary embodiments illustrated by the accompanying drawings. Wherever possible, the same reference numerals are used in the drawings and the descriptions to refer to the same or similar parts.

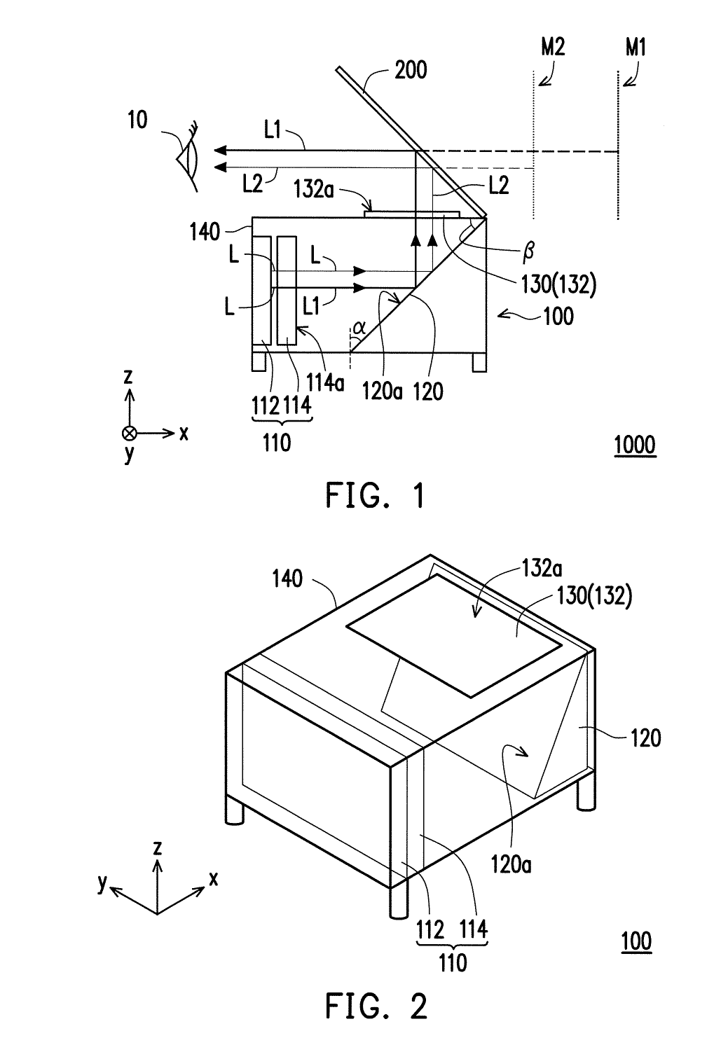

FIG. 1 is a schematic side view of a head-up display according to an embodiment of the invention. FIG. 2 is a schematic perspective view of a projection device of the head-up display of FIG. 1. For clarity, the figures are provided with the xyz Cartesian coordinate system, in which the direction x, the direction y, and the direction z are perpendicular to one another.

Referring to FIG. 1 and FIG. 2, a head-up display 1000 includes a projection device 100 and a light combining device 200. The projection device 100 includes a first image source 110, a first reflection device 120, and a second image source 130. In this embodiment, the first image source 110, the first reflection device 120, and the second image source 130 may be disposed in a housing 140, but the invention is not limited thereto. The first image source 110 is configured to provide a first image light L1. For example, the first image source 110 may include a light source 112 and a first display panel 114. The first display panel 114 is located between the light source 112 and the first reflection device 120. The light source 112 is configured to emit a light L. The light L passes through the first display panel 114 to form the first image light L1 with first image information. In this embodiment, the light source 112 is a backlight module that is capable of providing a uniform surface light source, for example. The backlight module may be a direct type backlight module, an edge type backlight module, or other suitable backlight modules, but the invention is not limited thereto. In this embodiment, the first display panel 114 may be a non-self-luminous display panel, e.g., liquid crystal display panels in various modes, including twisted nematic (TN), super twisted nematic (STN), vertical alignment (VA), in-plane switching (IPS), fringe field switching (FFS), or other suitable modes. It should be noted that, according to the invention, the first image source 110 does not necessarily include the light source 112 and the first display panel 114. In other embodiments, the first image source 110 may be other suitable types of image sources. For example, in another embodiment, the first image source 110 may be a self-luminous display panel (e.g., an organic electroluminescent display panel, a micro light emitting diode display panel, or other suitable types of display panels) that does not require the light source 112; and in yet another embodiment, the first image source 110 may be a miniature projector.

The first reflection device 120 is located beside the first image source 110. In this embodiment, a reflection surface 120a of the first reflection device 120 is inclined with respect to a display surface 114a of the first display panel 114, so as to reflect the first image light L1 from the display surface 114a to the light combining device 200. In this embodiment, an angle α is formed between the reflection surface 120a of the first reflection device 120 and the display surface 114a of the first display panel 114, wherein 0°<α<90°. The angle α may be adjusted according to the actual mechanism and optical design. In this embodiment, the first reflection device 120 is a reflecting mirror, for example, but the invention is not limited thereto.

The second image source 130 is located on the first reflection device 120 and configured to provide a second image light L2. In this embodiment, the second image source 130 may include a second display panel 132, and the second display panel 132 is located between the light combining device 200 and the first reflection device 120. In this embodiment, the second display panel 132 may selectively be a non-self-luminous display panel, e.g., liquid crystal display panels in various modes including twisted nematic (TN), super twisted nematic (STN), vertical alignment (VA), in-plane switching (IPS), fringe field switching (FFS), or other suitable modes. The light L emitted by the light source 112 is reflected by the first reflection device 120 and then passes through the second display panel 132 to form the second image light L2 with second image information. However, the invention is not limited thereto. In other embodiments, the second display panel 132 may also be a self-luminous display panel (e.g., an organic electroluminescent display panel, a micro light emitting diode display panel, or other suitable types of display panels) that does not rely on the light L emitted by the light source 112.

In this embodiment, the reflection surface 120a of the first reflection device 120 may be inclined with respect to a display surface 132a of the second display panel 132. An angle β is formed between the reflection surface 120a of the first reflection device 120 and the display surface 132a of the second display panel 132, wherein 0°<β<90°. The angle β may be adjusted according to the actual mechanism and optical design. In this embodiment, the display surface 114a of the first display panel 114 and the display surface 132a of the second display panel 132 are perpendicular to each other, for example, but the invention is not limited thereto. In other embodiments, other suitable angles may be formed between the display surface 114a of the first display panel 114 and the display surface 132a of the second display panel 132.

The second image source 130 is located between the light combining device 200 and the first reflection device 120. The first image light L1 is sequentially reflected by the first reflection device 120, passes through the second image source 130, and reflected by the light combining device 200 to be transmitted to eyes 10 of a user behind the light combining device 200, so as to form a first virtual image M1 in front of the light combining device 200. The second image light L2 is reflected by the light combining device 200 to be transmitted to the eyes 10 of the user behind the light combining device 200, so as to form a second virtual image M2 in front of the light combining device 200. An imaging position of the first virtual image M1 is farther from the light combining device 200 while an imaging position of the second virtual image M2 is closer to the light combining device 200. In other words, the first virtual image M1 seen by the eyes 10 corresponds to a foreground image, and the second virtual image M2 seen by the eyes 10 corresponds to a background image.

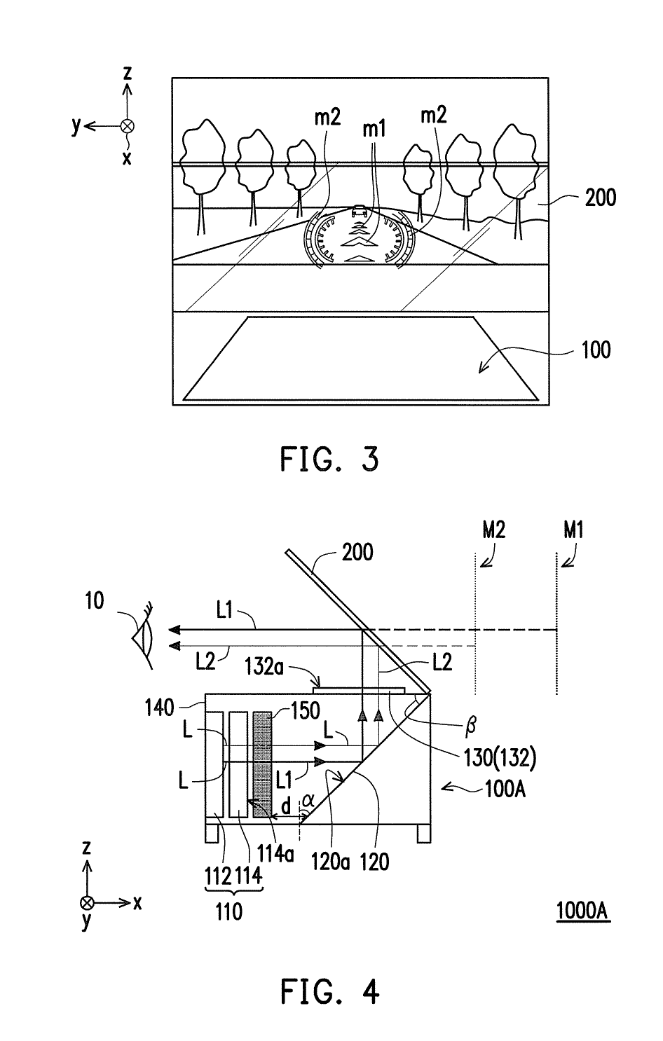

FIG. 3 illustrates a first image m1 and a second image m2 respectively formed by the first image light L1 and the second image light L2 captured by a camera behind the light combining device 200 of FIG. 1. Referring to FIG. 1 and FIG. 3, the first image m1 corresponds to the first virtual image M1 seen by the eyes 10 and the second image m2 corresponds to the second virtual image M2 seen by the eyes 10. As shown in FIG. 3, the first image m1 (or the first virtual image MD is the foreground image and the second image m2 (or the second virtual image M2) is the background image. By combining the first image m1 (or the first virtual image MD and the second image m2 (or the second virtual image M2), the head-up display 1000 is capable of displaying a stereoscopic image. Furthermore, in this embodiment, the first image m1 (or the first virtual image MD and the second image m2 (or the second virtual image M2) may be combined with a real scene (e.g., the traffic scene in FIG. 3) to achieve interaction for the head-up display 1000 to provide an augmented reality (AR) function, but the invention is not limited thereto.

In this embodiment, the light combining device 200 is a front windshield of a vehicle (e.g., an automobile, an airplane, etc.), for example. In other words, the head-up display 1000 of this embodiment is applicable to a vehicle for transportation. Nevertheless, the invention is not limited thereto. In other embodiments, the head-up display 1000 may also be applied to a wearable device (e.g., smart glasses with the augmented reality (AR) function); and the light combining device 200 may be mounted on a prism on the eyeglass frame.

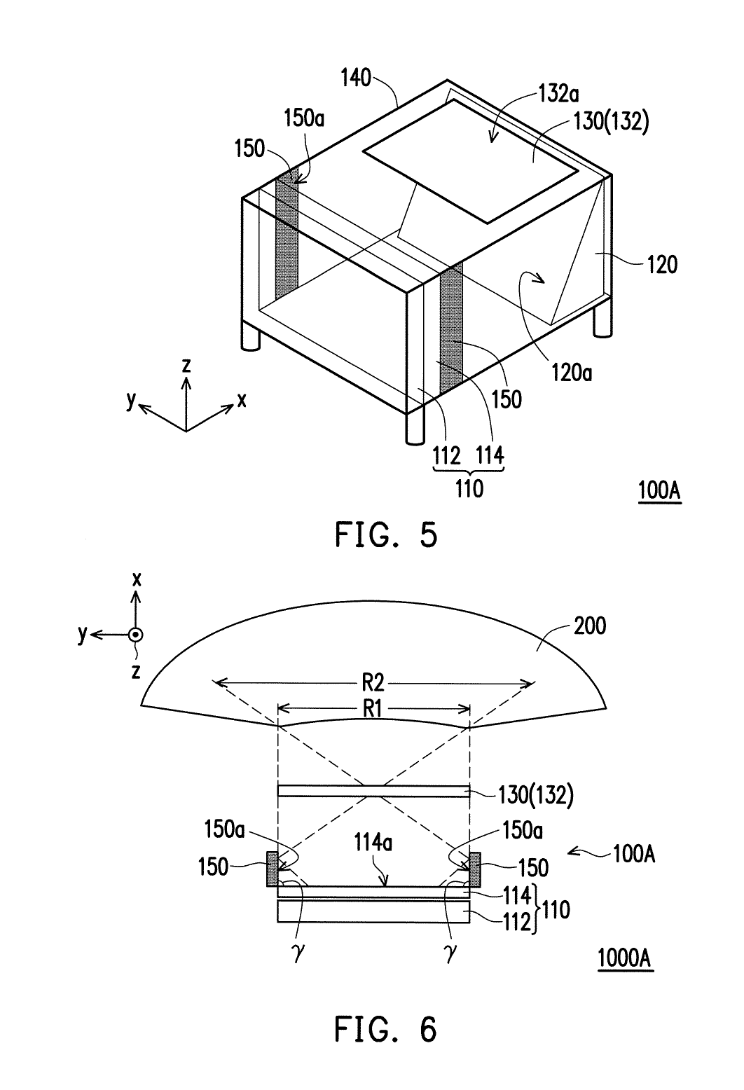

FIG. 4 is a schematic side view of the head-up display according to another embodiment of the invention. FIG. 5 is a schematic perspective view of the projection device of the head-up display of FIG. 4. FIG. 6 is a schematic top view of the head-up display of FIG. 4. Referring to FIG. 4 to FIG. 6, a head-up display 1000A is similar to the head-up display 1000 but differs from the head-up display 1000 in that: the head-up display 1000A further includes a second reflection device 150. The difference is explained in detail hereinafter.

The head-up display 1000A includes a projection device 100A and a light combining device 200. The projection device 100A includes a first image source 110, a first reflection device 120, and a second image source 130. The first image source 110 is configured to provide a first image light L1. The first reflection device 120 is located beside the first image source 110. The second image source 130 is located on the first reflection device 120 and configured to provide a second image light L2. The second image source 130 is located between the light combining device 200 and the first reflection device 120. The first image light L1 is sequentially reflected by the first reflection device 120, passes through the second image source 130, and reflected by the light combining device 200 to be transmitted to eyes 10 of a user behind the light combining device 200, so as to form a first virtual image M1 in front of the light combining device 200. The second image light L2 is reflected by the light combining device 200 to be transmitted to the eyes 10 of the user behind the light combining device 200, so as to form a second virtual image M2 in front of the light combining device 200.

Unlike the head-up display 1000, the projection device 100A of the head-up display 1000A further includes a plurality of second reflection devices 150. The second reflection devices 150 are respectively located on two opposite sides of the first image source 110. In this embodiment, the second reflection devices 150 are substantially located between the first display panel 114 and the first reflection device 120 and is separated from the first reflection device 120 by a distance d. A plurality of reflection surfaces 150a of the second reflection devices 150 are opposite to each other, and a plurality of angles γ are respectively formed between the reflection surfaces 150a of the second reflection devices 150 and the display surface 114a of the first display panel 114. Each angle γ is larger than or equal to 90°.

The first image light L1 is sequentially reflected by the reflection surfaces 150a of the second reflection devices 150, reflected by the first reflection device 120, passes through the second image source 130, and reflected by the light combining device 200 to be transmitted to the eyes 10 of the user behind the light combining device 200, so as to form the first virtual image M1 in front of the light combining device 200. Likewise, the light L emitted by the light source 112 is sequentially reflected by the reflection surfaces 150a of the second reflection devices 150, reflected by the first reflection device 120, passes through the second display panel 132, and reflected by the light combining device 200 to be transmitted to the eyes 10 of the user behind the light combining device 200, so as to form the second virtual image M2 in front of the light combining device 200.

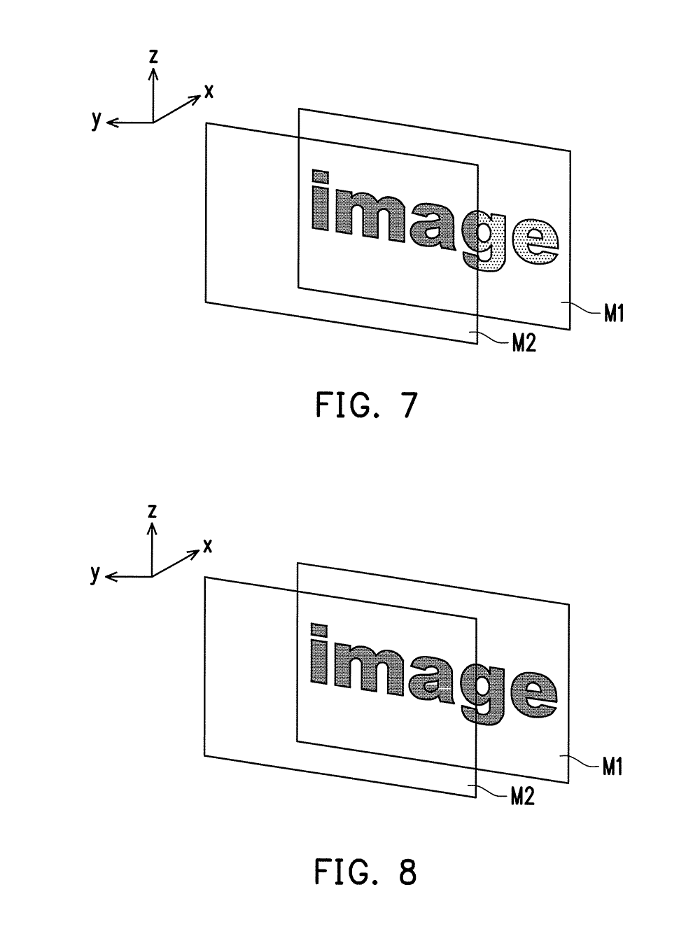

As shown in FIG. 6, due to reflection of the second reflection devices 150, the first image light L1 and the second image light L2 are diffused to a larger range. Thus, the visual range of the head-up display 1000A provided with the second reflection devices 150 is increased from a visible range R1 of the head-up display 1000 to a larger visible range R2. For example, in this embodiment, a viewing angle of the head-up display 1000A is increased from 0° of the head-up display 1000 to 30° on both the left and right sides. The difference between the display effects of the head-up display 1000A and the head-up display 1000 is described hereinafter with reference to FIG. 7 and FIG. 8 as an example.

FIG. 7 illustrates the first virtual image M1 and the second virtual image M2 displayed by the head-up display 1000 of FIG. 1, as seen at the viewing angle of 30°. FIG. 8 illustrates the first virtual image M1 and the second virtual image M2 displayed by the head-up display 1000A of FIG. 4, as seen at the viewing angle of 30°. Referring to FIG. 7 and FIG. 8, when the head-up display 1000 and the head-up display 1000A are both viewed at the viewing angle of 30°, the first virtual image M1 (i.e., the first virtual image M1 of FIG. 8) displayed by the head-up display 1000A provided with the second reflection devices 150 is less likely to fade out than the first virtual image M1 (i.e., the first virtual image M1 of FIG. 7) displayed by the head-up display 1000. In other words, when the second reflection devices 150 are disposed, the display effects of the head-up display 1000A are improved.

To sum up, the head-up display disclosed in an embodiment of the invention includes the first image source, the first reflection device, the second image source, and the light combining device. The first image source is configured to provide the first image light. The first reflection device is located beside the first image source. The second image source is located on the first reflection device and configured to provide the second image light. The second image source is located between the light combining device and the first reflection device. The first image light is sequentially reflected by the first reflection device, passes through the second image source, and reflected by the light combining device to be transmitted to the eyes of the user behind the light combining device, so as to form the first virtual image in front of the light combining device. The second image light is reflected by the light combining device to be transmitted to the eyes of the user behind the light combining device, so as to form the second virtual image in front of the light combining device. The imaging positions of the first virtual image and the second virtual image are different. By combining the first virtual image and the second virtual image, the head-up display is capable of displaying a stereoscopic image.

It will be apparent to those skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

1. A head-up display, comprising:
a first image source configured to provide a first image light;
a first reflection device located beside the first image source;
a second image source located on the first reflection device and configured to provide a second image light;
a light combining device, wherein the second image source is located between the light combining device and the first reflection device, and the first image light is sequentially reflected by the first reflection device, passes through the second image source, and reflected by the light combining device to be transmitted to eyes of a user; and the second image light is reflected by the light combining device to be transmitted to the eyes of the user, and
a plurality of second reflection devices respectively located on two opposite sides of the first image source, wherein the first image light is reflected to the first reflection device by the second reflection devices, the first reflection device and the light combining device are arranged in a first direction, and the plurality of second reflection devices are arranged in a second direction, and the first direction is perpendicular to the second direction.

2. The head-up display according to claim 1, wherein the first image source comprises:
a light source configured to emit a light; and
a first display panel, wherein the first display panel is located between the light source and the first reflection device, and the light passes through the first display panel to form the first image light.

3. The head-up display according to claim 2, wherein the second image source comprises:
a second display panel located between the light combining device and the first reflection device, wherein the light passes through the second display panel to form the second image light.

4. The head-up display according to claim 3, wherein a reflection surface of the first reflection device is inclined with respect to a display surface of the first display panel and a display surface of the second display panel.

5. The head-up display according to claim 3, wherein the display surface of the first display panel and the display surface of the second display panel are perpendicular to each other.

6. The head-up display according to claim 1, wherein the light combining device comprises a front windshield of a vehicle.

7. (canceled)

8. The head-up display according to claim 1, wherein the first image source comprises:
a light source configured to emit a light; and
a first display panel, wherein the first display panel is located between the light source and the first reflection device, and the light passes through the first display panel to form the first image light,
wherein the light is sequentially reflected by the second reflection devices, reflected by the first reflection device, and passes through the second image source to form the second image light.

9. The head-up display according to claim 8, wherein the second reflection devices are located between the first display panel and the first reflection device and is separated from the first reflection device by a distance.

10. The head-up display according to claim 8, wherein a plurality of reflection surfaces of the second reflection devices are opposite to each other, and a plurality of angles are respectively formed between the reflection surfaces of the second reflection devices and the display surface of the first display panel.

11. The head-up display according to claim 10, wherein the angles are larger than or equal to 90°.
